(19) United States
(12) Patent Application Publication
(10) Pub. No.: US 2020/0278089 A1
(43) Pub. Date: Sep. 3, 2020

(54) TUBULAR LIGHTING DEVICE AND LUMINAIRE

(71) Applicant: SIGNIFY HOLDING B.V., EINDHOVEN (NL)

(72) Inventors: ALEXANDER HENRICUS WALTHERUS VAN EEUWIJK, EINDHOVEN (NL); TIES VAN BOMMEL, HORST (NL); ROBERT JACOB PET, WAALRE (NL)

(21) Appl. No.: 16/759,979

(22) PCT Filed: Oct. 24, 2018
(86) PCT No.: PCT/EP2018/079163

§ 371 Date: Apr. 28, 2020

(30) Foreign Application Priority Data
Oct. 30, 2017 (EP) 17199151.6

(51) Int. Cl. F21K 9/65; F21K 9/27; F21K 9/69; F21V 3/06; F21K 9/66

(52) U.S. Cl. CPC F21K 9/65; F21K 9/27; F21Y 2115/10; F21V 3/063; F21K 9/66; F21K 9/69

(57) ABSTRACT

There is disclosed a tubular lighting device (20) comprising: an elongated tubular member (2) with an elongated light exit window (3) having a central area (3a) and two peripheral areas (3b, 3c); a first end cap (4); a second end cap (5); and a plurality of LEDs (9). Light exiting from the central area (3a) has a maximum intensity in a main illumination direction (I) of the tubular lighting device (20), and light exiting from each 5 peripheral area (3b, 3c) has a maximum intensity in a direction which is inclined away from the main illumination direction (I) and towards the closest end cap (4, 5). Thereby, when the tubular lighting device (20) is mounted in a luminaire behind a light exit cover, the uniformity of the intensity distribution of the light falling on the light exit cover is increased. luminaire is also disclosed.

### FIELD OF THE INVENTION

The present invention relates to a tubular lighting device and to a luminaire comprising such a lighting device.

### BACKGROUND OF THE INVENTION

Tubular lighting devices with light-emitting diodes (TLEDs) are currently replacing fluorescent tubes (conventional TL) in luminaires for office lighting, retail lighting and many other applications. The TLEDs are typically installed in elongate luminaires which have a cover window, such as an elongate diffuser. In such a configuration, the end caps of the TLED form dark areas which do no emit light. Compared to conventional TLs the dark areas are longer because of the accommodation of electronics/drivers for the LEDs. As a result, large, undesired dark areas appear at the end portions of the elongate diffuser of the luminaire. There is a perceived need for efforts aimed at reducing the problem of dark ends.

US 2015/0204487 discloses a LED-based replacement light comprising multiple LEDs, the LEDs having different logical control addresses associated among them, with eacht logical control address subjecting one or more of the LEDs associated therewith to individual control. The LEDs may be arranged to emit in a sideway direction as well.

JP2015185216 discloses a linear lighting device with an array of LEDs. The light distribution at the ends of this array of LEDs is adjusted by adding a wide-angle lens to the last LED in the array.

### SUMMARY OF THE INVENTION

It is therefore an object of the present invention to provide an improved or alternative tubular lighting device which overcomes or at least alleviate the above-discussed problems of the prior art.

According to a first aspect of the present invention, this and other objects are achieved by a tubular lighting device comprising: an elongated tubular member with an elongated light exit window extending between a first end and a second end of the elongated tubular member; a first end cap positioned at the first end of the elongated tubular member and a second end cap positioned at the second end of the elongated tubular member; an elongated substrate arranged inside the elongated tubular member; and a plurality of LEDs mechanically coupled to the elongated substrate and configured to emit light. The elongated light exit window has a central area and two peripheral areas, each peripheral area being arranged between the central area and a respective end of the elongated tubular member. The tubular lighting device is configured, for example by the provision of an optical redirection element, a wedge or some other element for redirecting light, so that light exiting from the central area has a maximum intensity in a main illumination direction of the tubular lighting device and so that light exiting from each peripheral area has a maximum intensity in a direction which is inclined away from the main illumination direction and towards the closest end cap.

By “intensity” is meant luminous intensity. The luminous intensity is often measured in candela.

The present invention is based on the understanding that TLEDs, which may be used for replacing conventional TLs in luminaires, may be configured so that large undesired areas do not appear at the end portions of the light exit cover of the luminaire. More precisely, this can be achieved by ensuring that the maximum intensity of the light from the peripheral areas of the light exit window of the elongated tubular member is inclined towards the end caps. Thereby, when the tubular lighting device is mounted in a luminaire behind a light exit cover, the uniformity of the intensity distribution of the light falling on the light exit cover may be increased. In sum, the tubular lighting device is configured to emit light having a luminous intensity distribution such that the uniformity of the brightness appearance, as measured in for example lux, of the light exit cover of the luminaire is increased.

The tubular lighting device may further comprise at least one optical element adapted to direct light emitted by a subset of the plurality of LEDs in the direction inclined away from the main illumination direction and towards the closest end cap. In this way, there is no need to use angularly spliced printed circuit boards (PCBs). Angularly spliced PCBs have been used in another type of lighting device than TLEDs, namely in a surface-mounting lamp as disclosed in CN203322832U. However, electrically coupling of such angularly spliced PCBs involves relatively laborious and complex manufacturing steps. Furthermore, a design with angularly spliced PCBs may be not robust and may need extra support elements within the housing to keep the PCBs correctly positioned.

The at least one optical element may be provided to at least one of the two peripheral areas of the elongated light exit window. The at least one optical element may comprise refractive structures in at least one of the two peripheral areas of the elongated light exit window.

The at least one optical element may be provided to at least one LED of the subset. The at least one optical element may be selected from the group consisting of a tilted reflector, a tilted total internal reflection (TIR) element, a refractive grating, and a (curved) light guide.

At least one of a subset of the plurality of LEDs may be a top emitting LED positioned at an angle relative to the elongated substrate so as to emit light in the direction inclined away from the main illumination direction and towards the closest end cap. Here too, there is no need to use angularly spliced PCBs.

At least one of a subset of the plurality of LEDs may be a side emitting LED associated with one of the two peripheral areas and adapted to emit light in a direction towards the closest end cap. Here too, there is no need to use angularly spliced PCBs. By an LED being “associated with” a certain area is meant that most of the light that the LED emits leaves through that area.

The elongated light exit window may have two outer areas, each outer area being arranged between a respective peripheral area and a respective end of the elongated tubular member, and the tubular lighting device may be configured so that light exiting from each outer area has a maximum intensity in a direction which is different than that of the light exiting from the peripheral areas.

The tubular lighting device may be configured so that light exiting from each outer area has a maximum intensity in a direction which is the same as the main illumination direction of the tubular lighting device. The outer areas separate the peripheral areas from the end caps, and, by not arranging the peripheral areas right next to the end caps, the risk of the end caps blocking some of the light from the peripheral areas is reduced.

The tubular lighting device may be configured so that light exiting from each outer area has a maximum intensity in a direction which is more inclined away from the main illumination direction and towards the closest end cap than that of the light exiting the peripheral areas. Thereby, there is a gradual redirection of light near the end caps to the light exit cover of the luminaire, something which may result in an even more uniform brightness appearance of the light exit cover of the luminaire.

The tubular lighting device may be configured such that a subset of the plurality of LEDs, which subset is associated with the central area of the elongated light exit window, is powered with a lower current than the LEDs associated with the two peripheral areas. The light exiting from an LED associated with a peripheral area is distributed to a larger area of the light exit cover of the luminaire than the light from an LED associated with the central area. This can be compensating for by supplying more power to the LEDs associated with the peripheral areas so that they generate more light. Thereby, the uniformity of the light intensity distribution on the light exit cover of the luminaire is improved.

The longitudinal pitch of a subset of the plurality of LEDs, which subset is associated with the central area of the elongated light exit window, may be larger than that of the LEDs associated with the two peripheral areas. Thus, the density of LEDs may be higher close to the end caps than at the center of the light exit window. This is another way of compensating for the fact that light exiting from an LED associated with a peripheral area is distributed to a larger area of the light exit cover of the luminaire than the light from an LED associated with the central area.

The elongated substrate may be rectilinear, and the tubular lighting device may be configured so that light coming from a subset of the LEDs mechanically coupled to the rectilinear elongated substrate and exiting from the central area has a maximum intensity in the main illumination direction of the tubular lighting device and so that light coming from another subset of the LEDs mechanically coupled to the rectilinear elongated substrate and exiting from each peripheral area has a maximum intensity in the direction which is inclined away from the main illumination direction and towards the closest end cap. Hence, a single rectilinear substrate may be used instead of several angularly spliced PCBs, which may facilitate production of the lighting device.

The central area of the elongated light exit window may have different optical properties than the two peripheral areas. For example, the peripheral areas may be transparent or refractive, and the central area may be translucent.

According to a second aspect of the present invention, there is presented a luminaire comprising at least one tubular lighting device according to the first aspect of the present invention. The effects and features of the second aspect of the present invention are similar to those of the first aspect of the invention.

It is noted that the present invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a schematic cross-sectional side view of a luminaire with a tubular lighting device according to an example embodiment of the present invention.

FIG. 2 shows a schematic cross-sectional side view of the tubular lighting device in FIG. 1.

FIGS. 3, 4 and 5 show light intensity curves on arbitrary scales.

FIGS. 6 to 12 show schematic cross-sectional side views of tubular lighting devices according to various example embodiments of the present invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

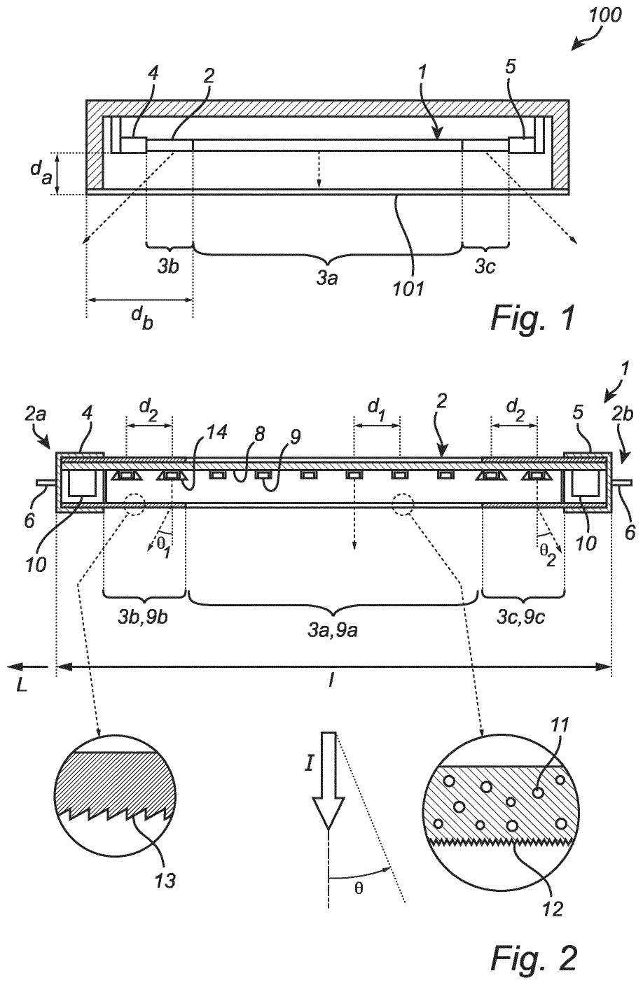

With reference to FIGS. 1 to 5, a luminaire 100 with a tubular lighting device 1 will now be described. The luminaire 100 is intended to be mounted to a ceiling. For example, the luminaire 100 may hang in wires that are attached to the ceiling. The tubular lighting device 1, which may be referred to as a TLED, is installed inside the luminaire 100 so as to emit light towards a light exit cover 101 of the luminaire 100. The light exit cover 101 of the luminaire 100 is adapted to transmit the light emitted by the tubular lighting device 1 to the surroundings of the luminaire 100. The light exit cover 101 is in this case planar, although this may or may not be the case in a different example. The light exit cover 101 may for example have a curved shape.

FIG. 2 shows the tubular lighting device 1 in more detail. The tubular lighting device 1 is in this case straight and has a length 1 in a longitudinal direction L of the tubular lighting device 1. The length 1 varies depending on the application, but is usually in the range from 25 cm to 160 cm, for example from 30 cm to 130 cm or from 50 cm to 125 cm. The tubular lighting device 1 has an elongated tubular member 2 with an elongated light exit window 3 through which light can pass. The distance da (see FIG. 1) between the light exit window 3 and the light exit cover 101 is typically in the range from 10 mm to 100 mm. The tubular member 2 can for example be made of glass, a ceramic material or a plastic material. The tubular member 2 has a circular cross-section transverse to the longitudinal direction L, but other shapes are conceivable. The cross section of the tubular member 2 may for example have the shape of a square, an ellipse or a polygon, in particular a regular polygon. The light exit window 3 extends between a first end 2a and a second end 2b of the tubular member 2. The light exit window 3 has a central area 3a and first and second peripheral areas 3b, 3c, each peripheral area 3b, 3c being arranged between the central area 3a and a respective end of the elongated tubular member 2. Differently stated, one peripheral area 3b is located adjacent to the first end 2a of the tubular member 2, and the other peripheral area 3c is located adjacent to the second end 2b of the tubular member 2. The first and second ends 2a, 2b are the longitudinal ends of the tubular member 2. Typically, the two peripheral areas 3b, 3c together constitute 10% to 40% of the total area of the light exit window 3. In FIG. 1, the distance between the end of the first peripheral area 3b that is proximal to the central area 3a and the closest end of the luminaire 100 is denoted by db, this distance typically being in the range from 30 mm to 150 mm. The corresponding statement holds for the second peripheral area 3c.

A first end cap 4 is positioned at the first end 2a of the tubular member 2, and a second end cap 5 is positioned at the second end 2b of the tubular member 2. The peripheral areas 3b, 3c are located between the central area 3a and a respective one of the caps 4, 5. Thus, the peripheral areas 3b, 3c are located adjacent to a respective one of the end caps 4, 5. The end caps 4, 5 may be cylindrical. The end caps 4, 5 may for example be made of a plastic material or a metal. In the illustrated example, both end caps 4, 5 include a pin 6 configured to electrically connect the tubular lighting device 1. The pins 6 are also configured to attach the tubular lighting device 1 to a luminaire. In a different example, only one of the end caps 4, 5 may be configured to electrically connect and attach the tubular lighting device 1.

An elongated substrate 8 is arranged inside the tubular member 2 and extends in the longitudinal direction L. In the illustrated example, the elongated substrate 8 is a rectilinear circuit board, such as a printed circuit board. The length of elongated substrate 8 may be at least 80% of the length of the light exit window 3, for example at least 85%, at least 90% or at least 95%. Several LEDs 9 are mechanically coupled to the substrate 8. The LEDs 9 are top emitting LEDs arranged to emit light towards the light exit window 3. Each of the LEDs 9 is electrically connected, via the substrate 8, to one of two drivers 10 for powering the LEDs 9. The drivers 10 are arranged inside the end caps 4, 5 and electrically connected to the pins 6. It may also be possible to arrange only one driver 10 in one of the end caps 4,5.

All of the LEDs 9 are in the illustrated example configured to emit white light, although in a different example the LEDs 9 may be configured to emit light of another color, and all of the LEDs 9 do not have to be configured to emit light of the same color. The LEDs 9 may for example be adapted to emit white light in the color temperature range from 2.000 K to 10.000 K, in particular from 2.500 K to 6.000 K, from 2.700 K to 5.000 K, or from 3.000 K to 4.000 K. The LEDs 9 may for example be adapted to emit light having a CRI of at least 70, at least 80, at least 85 or at least 90. The LEDs 9 may for example be adapted to emit white light which is within 15 SDCM from the black body line, in particular within 10 SDCM or within 5 SDCM. All of the LEDs 9 may be adapted to emit light having the same color temperature, and the color temperature may for example be within 15 SDCM, within 10 SDCM or within 5 SDCM. All of the LEDs 9 may be identical. All of the LEDs 9 may for example be mid power LEDs.

The LEDs 9 are in this case arranged in a straight row on the substrate 8. Other ways of arranging the LEDs 9 are conceivable. For example, the LEDs 9 could be arranged in a zigzag pattern or in two or more rows. A subset 9a of the LEDs is associated with the central area 3a of the light exit window 3, another subset 9b of the LEDs is associated with the peripheral area 3b close to the first end cap 4, and yet another subset 9c of the LEDs is associated with the peripheral area 3c close to the second end cap 5. As can be seen in FIG. 2, there are in this case two LEDs in each of the subsets 9b, 9c associated with the peripheral areas 3b, 3c. It should, however, be noted that there may be a different number of LEDs in these subsets 9b, 9c in a different embodiment. Typically, each of the subsets associated with the peripheral areas has two or more LEDs. In the following, the LEDs 9a associated with the central area 3a will be referred to as the central LEDs 9a, and the LEDs associated with the peripheral areas 3b, 3c will be referred to as the peripheral LEDs 9b, 9c. In FIG. 2, the pitch of the central LEDs 9a is denoted by d₁, and the pitch of the peripheral LEDs 9b, 9c is denoted by d₂. The pitches d₁, d₂ are in this case equal, although this may or may not be the case in a different example.

The central area 3a of the light exit window 3 is translucent. In this example, the light exit window 3 has, at the central area 3a, light scattering particles 11. Examples of suitable light scattering particles include Al₂O₃, BaSO₄ and TiO₂. The light scattering particles 11 may be air bubbles, typically in the micrometer range. The light exit window 3 also has, at the central area 3a, a random surface structure 12. The light scattering particles 11 and the surface structure 12 diffuse the light from the LEDs 9 that pass through the central area 3a of the light exit window 3. It should, however, be noted that both the light scattering particles 11 and the random surface structure 12 are optional features, and the tubular lighting device 1 may lack one or both of these features in a different example.

The tubular lighting device 1 is configured so that: light exiting from the central area 3a has a maximum intensity in a main illumination direction I; light exiting from the peripheral area 3b close to the first end cap 4 has a maximum intensity in a direction which is inclined away by an angle θ₁ from the main illumination direction I and towards the first end cap 4; and light exiting from the peripheral area 3c close to the second end cap 5 has a maximum intensity in a direction which is inclined away by an angle θ₂ from the main illumination direction I and towards the second end cap 5. The main illumination direction I is perpendicular to the longitudinal direction L and directed vertically downwards when the luminaire 100 is mounted to a ceiling. The main illumination direction I is thus parallel with a radial direction of the circular cross section of the tubular member 2. The main illumination direction I is directed towards the light exit cover 101 of the luminaire 100. In this case, the main illumination direction I is perpendicular to the light exit cover 101. The angles θ₁, θ₂ vary depending on the application, but are usually equal to each other and in the range from 20° to 85°, in particular from 30° to 80°. Also, the angles θ₁, θ₂ are usually equal to each other.

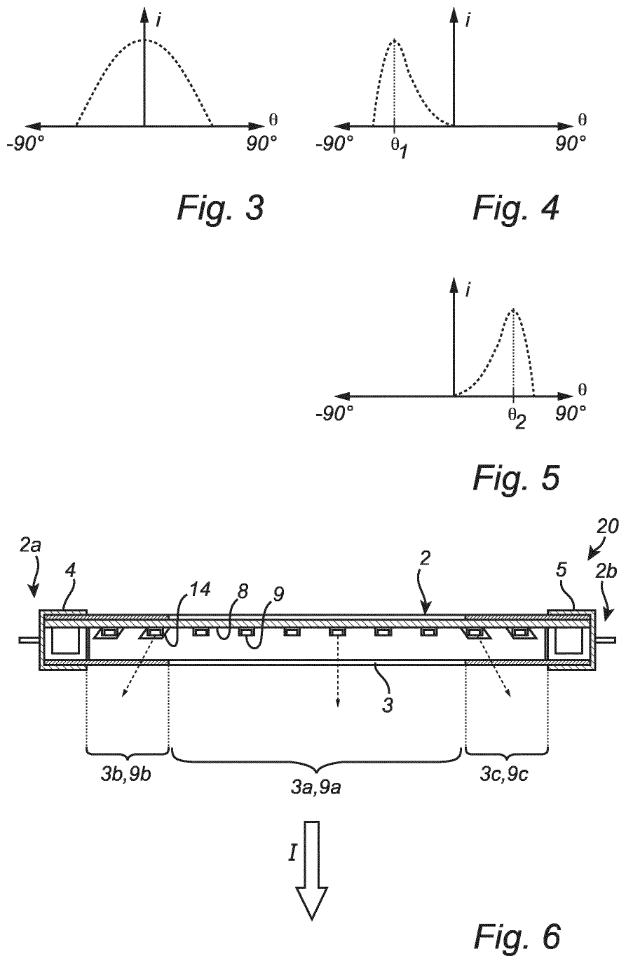

FIGS. 3 to 5 show intensity curves for light emitted by the tubular lighting device 1 in FIGS. 1 and 2. It should be noted that FIGS. 3 to 5 are merely schematic and that the scales of the axes are not necessarily the same in the different Figures. Specifically, FIG. 3 schematically shows a light intensity curve for light from the central area 3a. FIGS. 4 and 5 schematically show light intensity curves for light from the peripheral area 3b close to the first end 2a and from the peripheral area 3c close to the second end 3b, respectively. The light intensity i is plotted versus the angle θ. The angle θ is measured relative to the main illumination direction I, see FIG. 2. As can be seen in FIG. 3, the intensity distribution of the light from the central area 3a is in this case symmetrical with respect to the main illumination direction I and wide. As can be seen in FIGS. 4 and 5, the intensity distribution of the light from the peripheral areas 3b, 3c are in this case asymmetrical with respect to the main illumination direction I and narrow.

There are several ways of configuring the tubular lighting device 1 to emit light having the features discussed in the two preceding paragraphs.

In FIGS. 1-2, the light exit window 3 has optical elements 13 at the two peripheral areas 3b, 3c. The optical elements 13 are in this case refractive structures which are arranged on the outer side of the light exit window 3, i.e. on the side of the light exit window 3 that faces away from the LEDs 9. The optical elements 13 are adapted to re-direct light from the LED 9 that pass through the peripheral areas 3b, 3c towards the closest end cap 4, 5. Thus, the two peripheral areas 3b, 3c of the light exit window 3 have different optical properties than the central area 3a. The optical elements 13 help to increase the uniformity of the light intensity distribution on the light exit cover 101 of the luminaire 100, whereby the two ends of the tubular lighting device 1 appear less dark.

In order to further improve the uniformity of the light intensity distribution on the light exit cover 101 of the luminaire 100, the pitch d₂ of the peripheral LEDs 9b, 9c may be smaller than the pitch d₁ of the central LEDs 9a. Stated differently, the peripheral LEDs 9b, 9c may be more densely arranged than the central LEDs 9a. Yet another way of further improving the uniformity of the light intensity distribution on the light exit cover 101 of the luminaire 100 is to have the peripheral LEDs 9b, 9c emit light of a higher intensity than the central LEDs 9a, for example by providing more power to the peripheral LEDs 9b, 9c than to the central LEDs 9a. This helps to compensates for the fact that the light from the peripheral areas 3b, 3c is spread out compared to the light from the central area 3a.

As shown in FIG. 2, each of the peripheral LEDs 9b, 9c are provided with a collimator 14 for collimating the light emitted by the peripheral LEDs 9b, 9c. Specifically, the collimators 14 are adapted so that the collimated light is collimated in the main illumination direction I. The collimators 14 can for example be reflectors or TIR optics. It should be noted that the collimators 14 are optional. Also, a DBEF foil could be used instead of the collimators 14 to collimate the light emitted by the peripheral LEDs 9b, 9c. Such a DBEF foil would typically be arranged on the inside of the light exit window 3, i.e. on the side of the light exit window 3 that faces the LEDs 9.

FIG. 6 shows a tubular lighting device 20 which is similar to the tubular lighting device 1 discussed above in relation to FIGS. 1 to 5. However, the optical elements 21 of the tubular lighting device 20 shown in FIG. 4 are not provided to the peripheral areas 3b, 3c of the light exit window 203. Instead, the optical elements 214 are in this example provided to the peripheral LEDs 9b, 9c. More precisely, the optical elements 21 are in this case tilted reflectors or tilted TIR elements. Each peripheral LEDs 9b, 9c has an optical element 21 which is arranged to redirect the light emitted from the LED so that the emitted light is directed in a direction which is inclined away from the main illumination direction I and towards the closest end cap 5, 6. In this example, the central area 3a of the light exit window 3 is translucent, and the peripheral areas 3b, 3c of the light exit window 3 are transparent.

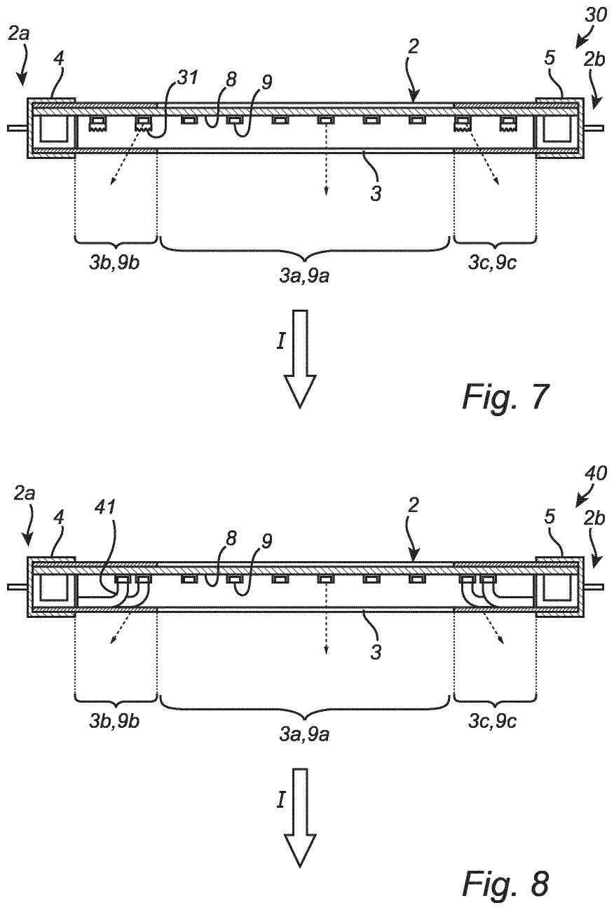

FIG. 7 shows a tubular lighting device 30 which is similar to the tubular lighting device 20 discussed above in relation to FIGS. 6. However, the optical elements 31 of the tubular lighting device 30 shown in FIG. 7 are refractive gratings positioned on top of the peripheral LEDs 9b, 9c. Such refractive gratings do not have to be positioned directly on top of the LEDs as in FIG. 7, but can be positioned close to the LEDs.

FIG. 8 shows a tubular lighting device 40 which is similar to the tubular lighting devices 20, 30 discussed above in relation to FIGS. 6 and 7. However, the optical elements 41 of the tubular lighting device 40 shown in FIG. 8 are curved light guides.

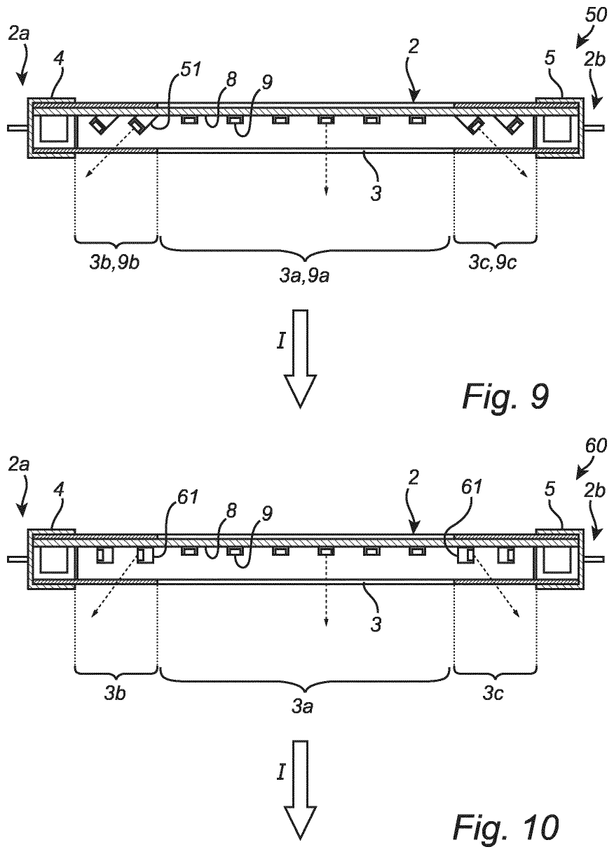

FIG. 9 shows a tubular lighting device 50 which is similar to the tubular lighting devices 1, 20, 30, 40 discussed above in relation to FIGS. 1 to 8. However, the tubular lighting device 50 in FIG. 9 is provided with a plurality of wedges 51. Each of the peripheral LEDs 9b, 9c is here a top emitting LED and arranged on one of the wedges 51. Each wedge 51 is arranged on the substrate 8, between the substrate 8 and a peripheral LED 9b, 9c. As a result, the peripheral LEDs 9b, 9c are positioned at an angle relative to the elongated substrate 8 so as to emit light in a direction which is inclined away from the main illumination I direction and towards the closest end cap 4, 5.

FIG. 10 shows a tubular lighting device 60 which is similar to the tubular lighting devices 1, 20, 30, 40, 50 discussed above in relation to FIGS. 1 to 9. However, the peripheral LEDs 61 of the tubular lighting device 60 in FIG. 10 are side emitting LEDs adapted to emit light in a direction towards the closest end cap 4, 5. Thereby, the light emitted by the peripheral LEDs 61 will leave through the light exit window 3 in a direction which is inclined away from the main illumination I direction and towards the closest end cap 5, 6.

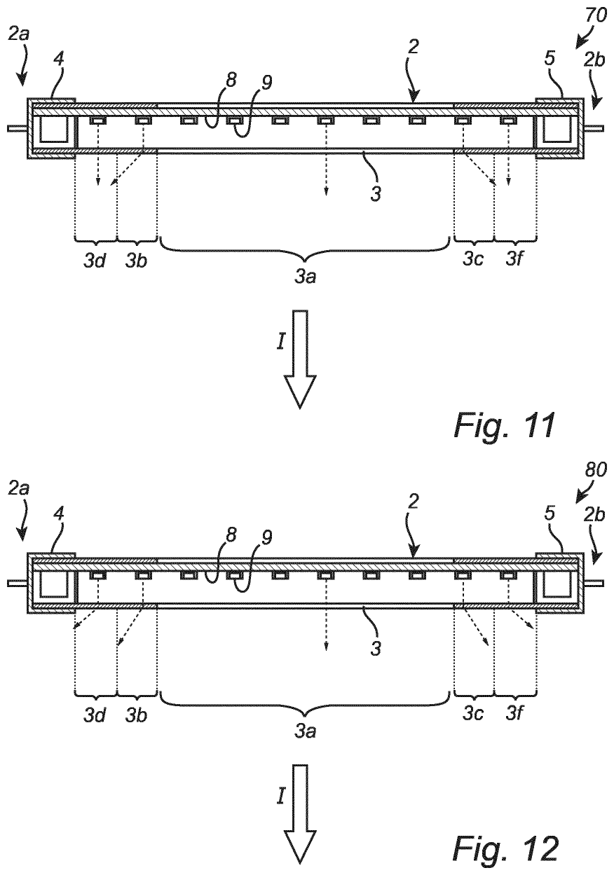

FIG. 11 shows a tubular lighting device 70 which is similar to the tubular lighting device 1 discussed above in relation to FIGS. 1 to 5. However, the light exit window 3 of the tubular lighting device 70 in FIG. 11 further has two outer areas 3d, 3e. Each outer area 3d, 3e is arranged between a respective peripheral area 3b, 3c and a respective end of the tubular member 2. Thus, each peripheral area 3b, 3c is arranged between the central area 3a and one of the outer areas 3d, 3e. The outer areas 3e, 3f are adapted so that light leaving through the outer areas 3d, 3f has a maximum intensity in the main illumination direction I. Thus, light exiting from each outer area 3d, 3e has a maximum intensity in a direction which is different than that of the light exiting from the peripheral areas 3b, 3c. This can for example be achieved by letting the outer areas 3e, 3f have the same optical properties as the central region 3a.

FIG. 12 shows a tubular lighting device 80 which is similar to the tubular lighting device 70 discussed above in relation to FIGS. 11. However, the outer areas 3d, 3f of the tubular lighting device 80 in FIG. 12 are adapted so that light exiting therefrom has a maximum intensity in a direction which is more inclined away from the main illumination direction I and towards the closest end cap 4, 5 than that of the light exiting the peripheral areas 3b, 3c. This can for example be achieved by providing the light exit window 3, at the outer areas 3d, 3f, with suitably adapted refractive structures.

It should be noted that the light exit window 3 may in a different embodiment have additional areas, similar to the outer areas 3d, 3f of the tubular lighting device 80 shown in FIG. 12, between the peripheral areas 3b, 3c and the ends 2a, 2b of the tubular member 2. Such additional areas may be adapted so that the angle between the main illumination direction I and the direction of the light having the maximum intensity gradually increases from the center of the light exit window 3 towards the end caps 4, 5.

It should also be noted that the tubular lighting devices 20, 30, 40, 50, 60 discussed above in relation to FIGS. 6 to 10 may have outer areas such as those discussed in relation to FIGS. 11 and 12. In the latter case, the light direction of the outer areas 3d, 3f may be achieved by associating optical elements 21, 31, 41 as shown in FIGS. 6 to 8 and/or wedges 51 as shown in FIG. 9 with the outer areas 3d, 3f and adapt the optical elements/wedges appropriately.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A tubular lighting device comprising:
an elongated tubular member with an elongated light exit window extending between a first end and a second end of the elongated tubular member;
a first end cap positioned at the first end of the elongated tubular member and a second end cap positioned at the second end of the elongated tubular member;
an elongated substrate arranged inside the elongated tubular member; and
a plurality of LEDs mechanically coupled to the elongated substrate and configured to emit light,
wherein the elongated light exit window has a central area and two peripheral areas, each peripheral area being arranged between the central area and a respective end of the elongated tubular member, and
wherein the tubular lighting device is configured so that light exiting from the central area has a maximum intensity in a main illumination direction (I) of the tubular lighting device and so that light exiting from each peripheral area has a maximum intensity in a direction which is inclined away from the main illumination direction (I) and towards the closest end cap.

2. The tubular lighting device according to claim 1, further comprising at least one optical element adapted to direct light emitted by a subset of the plurality of LEDs in said direction inclined away from the main illumination direction (I) and towards the closest end cap.

3. The tubular lighting device according to claim 2, wherein the at least one optical element is provided to at least one of the two peripheral areas of the elongated light exit window.

4. The tubular lighting device according to claim 3, wherein the at least one optical element comprises refractive structures in at least one of the two peripheral areas of the elongated light exit window.

5. The tubular lighting device according to claim 2, wherein the at least one optical element is provided to at least one LED of said subset.

6. The tubular lighting device according to claim 5, wherein the at least one optical element is selected from the group consisting of a tilted reflector, a tilted total internal reflection element, a refractive grating, and a light guide.

7. The tubular lighting device according to any prcccding claim 1, wherein at least one of a subset of the plurality of LEDs is a top emitting LED positioned at an angle relative to the elongated substrate so as to emit light in said direction inclined away from the main illumination direction (I) and towards the closest end cap.

8. The tubular lighting device according to any prcccding claim 1, wherein at least one of a subset of the plurality of LEDs is a side emitting LED associated with one of the two peripheral areas and adapted to emit light in a direction towards the closest end cap.

9. The tubular lighting device according to claim 1, wherein the elongated light exit window further has two outer areas, each outer area being arranged between a respective peripheral area and a respective end of the elongated tubular member, and wherein the tubular lighting device is configured so that light exiting from each outer area has a maximum intensity in a direction which is different than that of the light exiting from the peripheral areas.

10. The tubular lighting device according to claim 9, wherein the tubular lighting device is configured so that light exiting from each outer area has a maximum intensity in a direction which is the same as the main illumination direction of the tubular lighting device.

11. The tubular lighting device according to claim 9, wherein the tubular lighting device is configured so that light exiting from each outer area has a maximum intensity in a direction which is more inclined away from the main illumination direction (I) and towards the closest end cap than that of the light exiting the peripheral areas.

12. The tubular lighting device according to claim 1, configured such that a subset of the plurality of LEDs, which subset is associated with the central area of the light exit window, is powered with a lower current than the LEDs associated with the two peripheral areas.

13. The tubular lighting device according to claim 1, wherein the longitudinal pitch of a subset of the plurality of LEDs, which subset is associated with the central area of the light exit window, is larger than that of the LEDs associated with the two peripheral areas.

14. The tubular lighting device according to claim 1, wherein the elongated substrate is rectilinear, and wherein the tubular lighting device is configured so that light coming from a subset of the LEDs mechanically coupled to the rectilinear elongated substrate and exiting from the central area has a maximum intensity in the main illumination direction (I) of the tubular lighting device and so that light coming from another subset of the LEDs mechanically coupled to the rectilinear elongated substrate and exiting from each peripheral area has a maximum intensity in said direction which is inclined away from the main illumination direction (I) and towards the closest end cap.

15. A luminaire comprising at least one tubular lighting device according to claim 1.
